(19) United States
(12) Patent Application Publication
(10) Pub. No.: US 2017/0166395 A1
(43) Pub. Date: Jun. 15, 2017

(54) BAG SECURING TRASH CAN SYSTEM

(71) Applicant: Romaine Taylor, Sacramento, CA (US)

(72) Inventor: Romaine Taylor, Sacramento, CA (US)

(21) Appl. No.: 14/963,979

(22) Filed: Dec. 9, 2015

(51) Int. Cl. B65F 1/06; B65F 1/14

(52) U.S. Cl. CPC B65F 1/06; B65F 1/163; B65F 1/1646

(57) ABSTRACT

A trash can system includes a trash can. A bag is removably positioned within the trash can. A lid is hingedly coupled to the trash can such that the lid selectively covers the opening. A gripping unit is movably coupled to the trash can. The gripping unit may be manipulated. The gripping unit is positionable in an engaging position having the gripping unit engaging the bag. Thus, the bag is inhibited from falling into the trash can. The gripping unit is positionable in a releasing position such that the bag is removable from the trash can.

### BACKGROUND OF THE DISCLOSURE

### Field of the Disclosure

The disclosure relates to trash can devices and more particularly pertains to a new trash can device for removably coupling a bag to a trash can.

### SUMMARY OF THE DISCLOSURE

An embodiment of the disclosure meets the needs presented above by generally comprising a trash can. A bag is removably positioned within the trash can. A lid is hingedly coupled to the trash can such that the lid selectively covers the opening. A gripping unit is movably coupled to the trash can. The gripping unit may be manipulated. The gripping unit is positionable in an engaging position having the gripping unit engaging the bag. Thus, the bag is inhibited from falling into the trash can. The gripping unit is positionable in a releasing position such that the bag is removable from the trash can.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a trash can system according to an embodiment of the disclosure.

FIG. 2 is a front perspective view of an embodiment of the disclosure.

FIG. 3 is a top view of an embodiment of the disclosure.

FIG. 4 is a left side view of an embodiment of the disclosure.

FIG. 5 is a cross sectional view taken along line 5-5 of FIG. 1 of an embodiment of the disclosure.

FIG. 6 is a front phantom view of an embodiment of the disclosure.

### DESCRIPTION OF THE PREFERRED EMBODIMENT

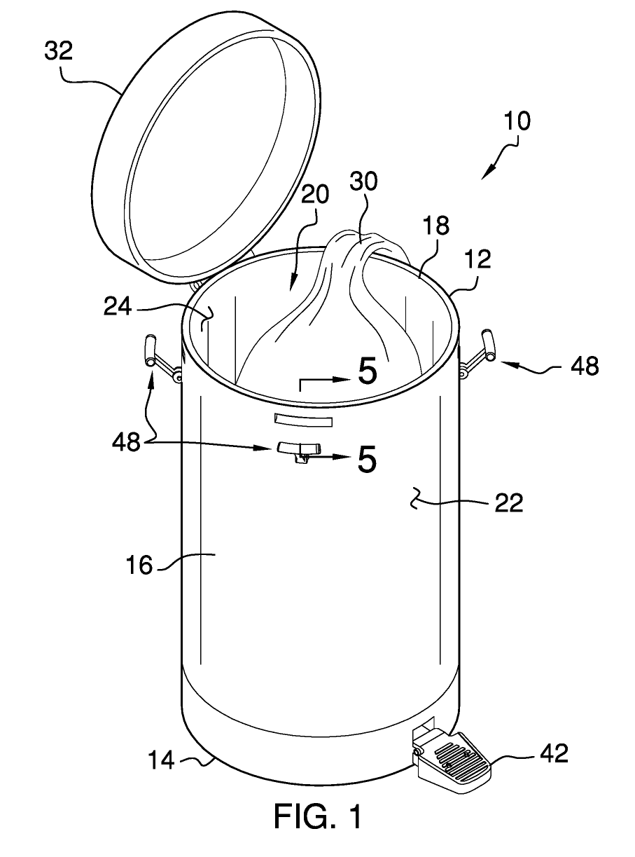

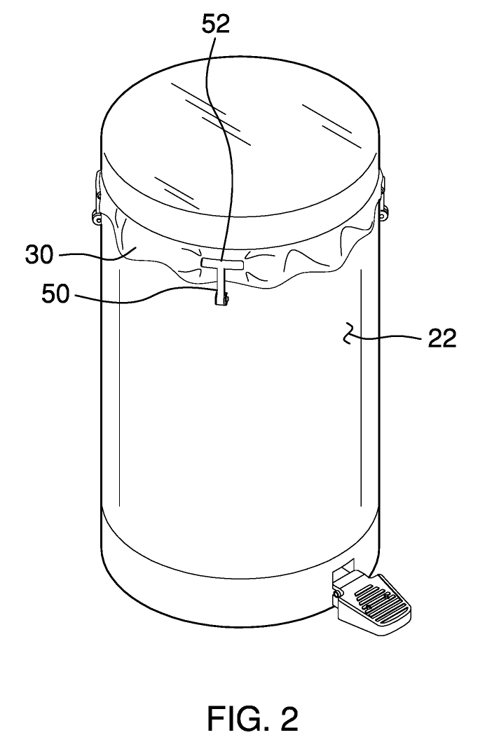

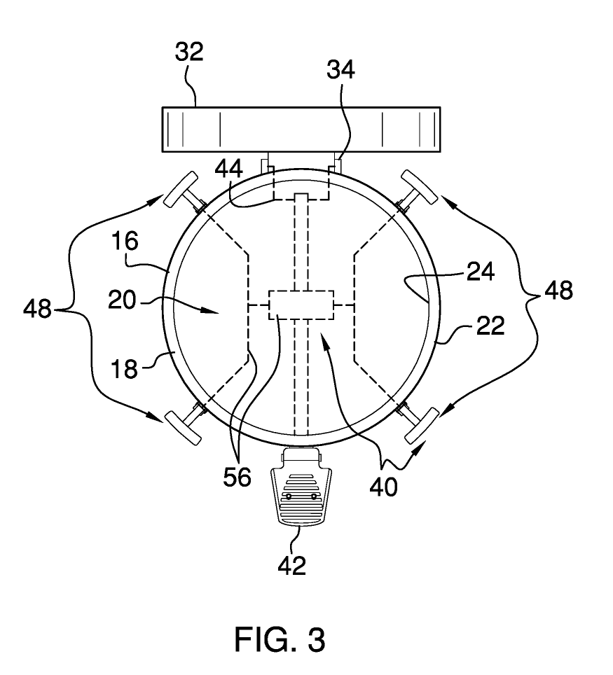

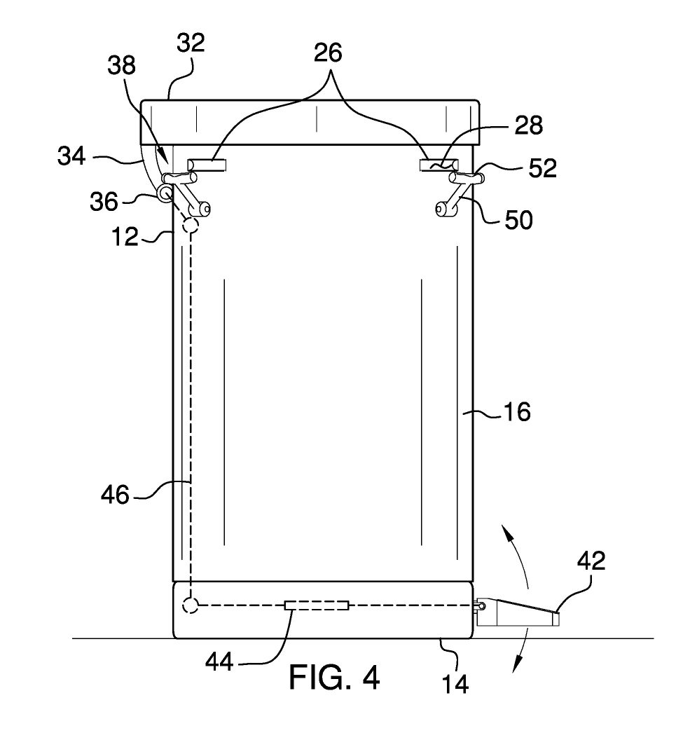

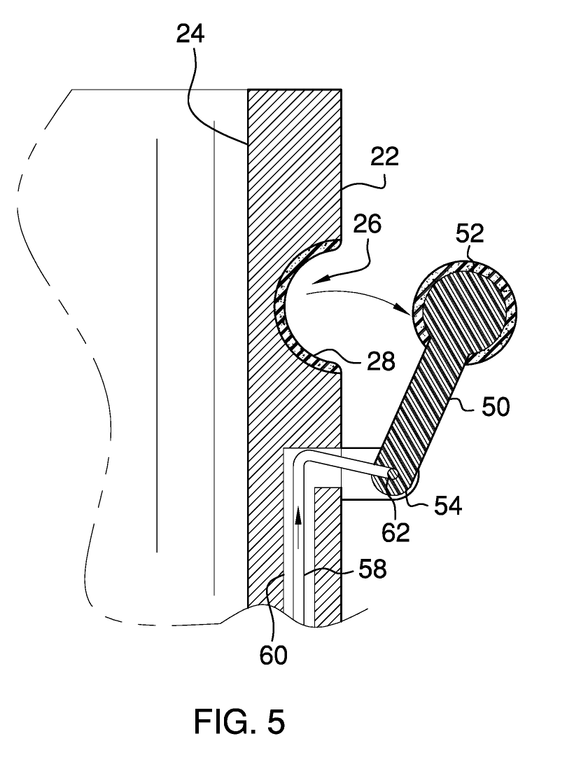

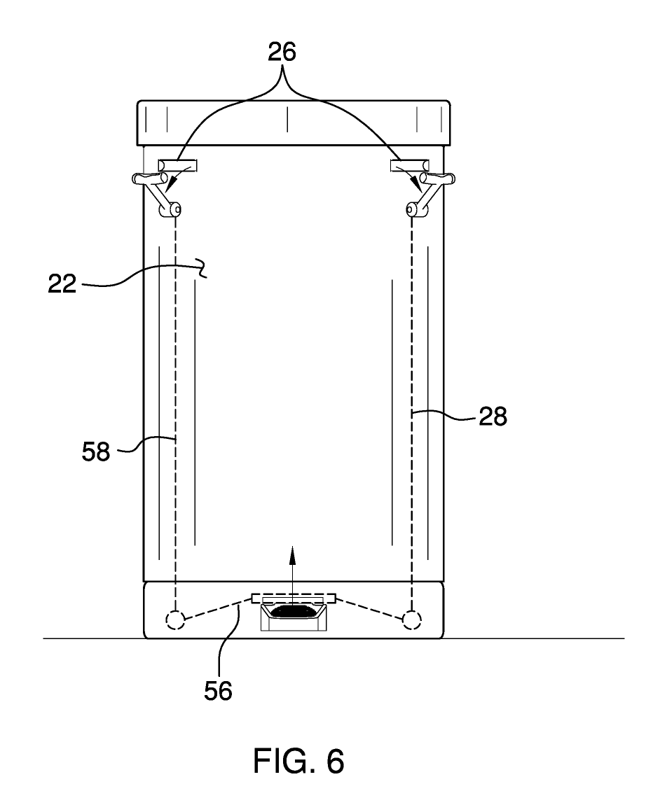

With reference now to the drawings, and in particular to FIGS. 1 through 6 thereof, a new trash can device embodying the principles and concepts of an embodiment of the disclosure and generally designated by the reference numeral 10 will be described.

As best illustrated in FIGS. 1 through 6, the trash can system 10 generally comprises a trash can 12 that has a basal wall 14 and a peripheral wall 16 extending upwardly from the basal wall 14. The peripheral wall 16 has a distal edge 18 with respect to the basal wall 14 and the distal edge 18 defines an opening 20 into the trash can 12. The peripheral wall 16 has an outer surface 22 and an inner surface 24. The outer surface 22 has a plurality of slots 26 extending inwardly toward the inner surface 24. The slots 26 are spaced apart from each other and are distributed around the peripheral wall 16. Each of the slots 26 is positioned closer to the distal edge 18 than the basal wall 14. Each of the slots 26 has a bounding surface 28 and the bounding surface 28 may comprise a resiliently compressible material.

A bag 30 is removably positioned within the trash can 12. The bag 30 is manipulated to extend downwardly along the outer surface 22. Thus, the bag 30 covers each of the slots 26. The bag 30 may comprise a trash bag of any conventional design.

A lid 32 is hingedly coupled to the trash can 12 such that the lid 32 selectively covers the opening 20. An arm 34 is coupled between the lid 32 and the outer surface 22 and the arm 34 has a distal end 36 with respect to the lid 32. The distal end 36 is hingedly coupled to the outer surface 22. The arm 34 is arcuate between the lid 32 and the distal end 36 to define a space 38 between the arm 34 and the outer surface 22. The bag 30 is positionable within the space 38 when the bag 30 is manipulated to extend downwardly along the outer surface 22. Thus, the bag 30 does not interfere with the lid 32 being positioned between a closed position and an open position.

A gripping unit 40 is movably coupled to the trash can 12 and the gripping unit 40 may be manipulated. The gripping unit 40 is positionable in an engaging position. The gripping unit 40 engages the bag 30 such that the bag 30 is inhibited from falling into the trash can 12. The gripping unit 40 is positionable in a releasing position. Thus, the bag 30 is removable from the trash can 12.

The gripping unit 40 comprises a pedal 42 that is movably coupled to the peripheral wall 16 and the pedal 42 may be manipulated. The pedal 42 is positioned closer to the basal wall 14 than the distal edge 18. The pedal 42 is urgeable into an opening position and a releasing position. The pedal 42 may be urged downwardly when the pedal 42 is urged into the opening position. The pedal 42 may be urged upwardly when the pedal 42 is urged into the releasing position and the pedal 42 may be biased into a neutral position.

A lid actuator 44 is positioned within the basal wall 14 and the pedal 42 is mechanically coupled to the lid actuator 44. The lid actuator 44 may comprise a hydraulic actuator, a spring loaded actuator or any other mechanical actuator. A lid arm 46 extends between the lid actuator 44 and the lid 32. The lid arm 46 is positioned between the inner surface 24 and the outer surface 22 of the peripheral wall 16. The lid arm 46 urges the lid 32 into the open position when the pedal 42 is urged into the opening position. The lid actuator 44 biases the lid 32 into the closed position.

A plurality of clips 48 is provided. Each of the clips 48 comprises a first arm 50 that is coupled to a second arm 52. The second arm 52 is oriented transversely with respect to the first arm 50 such that each of the clips 48 has a T-shape. The first arm 50 has a distal end 54 with respect to the second arm 52. The distal end 54 is hingedly coupled to the outer surface 22 of the peripheral wall 16.

The clips 48 are spaced apart from each other and distributed around the outer surface 22. Each of the clips 48 is aligned with an associated one of the slots 26. Each of the clips 48 is biased into an engaging position having the second arm 52 of each of the clips 48 being positioned in the associated slot 26. The bag 30 is compressed between the second arm 52 of each of the clips 48 and the associated slot when the clips 48 are biased into the engaging position.

Each of the clips 48 is urgeable into a releasing position having the second arm 52 of each of the clips 48 being spaced from the associated slot 26. Thus, the bag 30 is removable from the trash can 12. The second arm 52 of each of the clips 48 may be wrapped with a resiliently compressible material. Thus, the bag 30 frictionally engages the bounding surface 28 of each of the slots 26 and the second arm 52 of each of the clips 48 when the clips 48 are in the engaging position.

A clip actuator 56 is positioned within the basal wall 14 and the pedal 42 is mechanically coupled to the clip actuator 44. The clip actuator 44 may comprise a hydraulic actuator, a spring loaded actuator or any other mechanical actuator. A plurality of clip arms 58 is provided. Each of the clip arms 58 is coupled between the clip actuator 44 and an associated one of the clips 48.

The peripheral wall 16 may have a plurality of conduits 60 positioned between the inner surface 24 and the outer surface 22. The conduits 60 may be vertically oriented in the peripheral wall 16. The lid arm 46 may be positioned within one of the conduits 60. Each of the clip arms 58 is positioned between the inner surface 24 and the outer surface 22 of the peripheral wall 16. Each of the clip arms 58 may be positioned within one of the conduits 60. Thus, the lid arm 46 and each of the clip arms 58 may move freely within the peripheral wall 16.

Each of the clip arms 58 has a distal end 62 with respect to the clip actuator 56. The distal end 62 of each of the clip arms 58 extends outwardly through the peripheral wall 16. The distal end 62 of each of the clip arms 58 is coupled to the distal end 54 of the associated clip 48. Thus, the clip actuator 56 biases each of the clips 48 into the engaging position.

In use, pedal 42 is urged into the opening position and the bag 30 is positioned within the trash can 12. The bag 30 is manipulated to extend downwardly along the outer surface 22 of the trash can 12. The pedal 42 is urged into the releasing position and the bag 30 is positioned between each of the clips 48 and the slots 26. The pedal 42 is released into the neutral position. The clip actuator 56 biases each of the clips 48 into the engaging position. Thus, the bag 30 is frictionally coupled to the outer surface 22 of the trash can 12.

Trash is thrown into the bag when the clips secure the bag to the trash can. Thus, the clips inhibit the trash from pulling the bag into the trash can. The pedal is urged into the releasing position. The bag is removed from the slots. The pedal is urged into the opening position and the bag is removed from the trash can when the bag is full. The in use process is repeated when an empty bag is positioned within the trash can.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. A bag securing trash can system comprising:
a trash can;
a bag being removably positioned within said trash can;
a lid being hingedly coupled to said trash can such that said lid selectively covers said opening; and
a gripping unit being movably coupled to said trash can wherein said gripping unit is configured to be manipulated, said gripping unit being positionable in an engaging position having said gripping unit engaging said bag such that said bag is inhibited from falling into said trash can, said gripping unit being positionable in a releasing position such that said bag is removable from said trash can; and
wherein said trash can has a basal wall and a peripheral wall extending upwardly from said basal wall, said peripheral wall having a distal edge with respect to said basal wall, said distal edge defining an opening into said trash can, said peripheral wall having an outer surface and an inner surface, said outer surface having a plurality of slots extending inwardly toward said inner surface, said slots being spaced apart from each other and being distributed around said peripheral wall, each of said slots being positioned closer to said distal edge than said basal wall.

3. The system according to claim 2, wherein said lid has an arm being coupled between said lid and said outer surface, said arm having a distal end with respect to said lid, said distal end being hingedly coupled to said outer surface, said arm being arcuate between said lid and said distal end to define a space between said arm and said outer surface, said bag being positionable within said space when said bag extends downwardly along said outer surface.

4. The system according to claim 2, wherein said gripping unit comprises a pedal being movably coupled to said peripheral wall wherein said pedal is configured to be manipulated, said pedal being positioned closer to said basal wall than said distal edge, said pedal being urgeable into an opening position and a releasing position.

5. The system according to claim 4, further comprising a lid actuator being positioned within said basal wall, said pedal being mechanically coupled to said lid actuator.

6. The system according to claim 5, further comprising a lid arm extending between said lid actuator and said lid, said lid arm being positioned between said inner surface and said outer surface of said peripheral wall, said lid arm urging said lid into an open position when said pedal is urged into said opening position, said lid actuator biasing said lid into a closed position.

7. The system according to claim 2, further comprising a plurality of clips, each of said clips comprising a first arm being coupled to a second arm, said second arm being oriented transversely with respect to said first arm such that each of said clips has a T-shape, said first arm having a distal end with respect to said second arm, said distal end being hingedly coupled to said outer surface of said peripheral wall.

8. The system according to claim 7, wherein said clips are spaced apart from each other and distributed around said outer surface, each of said clips being aligned with an associated one of said slots, each of said clips being biased into an engaging position having said second arm of each of said clips being positioned in said associated slot, said bag being compressed between said second arm of each of said clips and said associated slot when said clips are biased into said engaging position.

9. The system according to claim 8, wherein each of said clips is urgeable into a releasing position having said second arm of each of said clips being spaced from said associated slot such that said bag is removable from said trash can.

10. The system according to claim 4, further comprising a clip actuator being positioned within said basal wall, said pedal being mechanically coupled to said clip actuator.

11. The system according to claim 10, further comprising:
a plurality of clips; and
a plurality of clip arms, each of said clip arms being coupled between said clip actuator and an associated one of said clips, each of said clip arms being positioned between said inner surface and said outer surface of said peripheral wall, each of said clip arms having a distal end with respect to said clip actuator.

12. The system according to claim 11, wherein:
each of said clips has a distal end; and
said distal end of each of said clip arms extends outwardly through said peripheral wall, said distal arm of each of said clip arms being coupled to said distal end of said associated clip, said clip actuator biasing each of said clips into an engaging position.

13. A bag securing trash can system comprising:
a trash can having a basal wall and a peripheral wall extending upwardly from said basal wall, said peripheral wall having a distal edge with respect to said basal wall, said distal edge defining an opening into said trash can, said peripheral wall having an outer surface and an inner surface, said outer surface having a plurality of slots extending inwardly toward said inner surface, said slots being spaced apart from each other and being distributed around said peripheral wall, each of said slots being positioned closer to said distal edge than said basal wall;
a bag being removably positioned within said trash can, said bag extending downwardly along said outer surface such that said bag covers each of said slots;
a lid being hingedly coupled to said trash can such that said lid selectively covers said opening, said lid having an arm being coupled between said lid and said outer surface, said arm having a distal end with respect to said lid, said distal end being hingedly coupled to said outer surface, said arm being arcuate between said lid and said distal end to define a space between said arm and said outer surface, said bag being positionable within said space when said bag extends downwardly along said outer surface; and
a gripping unit being movably coupled to said trash can wherein said gripping unit is configured to be manipulated, said gripping unit being positionable in an engaging position having said gripping unit engaging said bag such that said bag is inhibited from falling into said trash can, said gripping unit being positionable in a releasing position such that said bag is removable from said trash can, said gripping unit comprising:
a pedal being movably coupled to said peripheral wall wherein said pedal is configured to be manipulated, said pedal being positioned closer to said basal wall than said distal edge, said pedal being urgeable into an opening position and a releasing position,
a lid actuator being positioned within said basal wall, said pedal being mechanically coupled to said lid actuator,
a lid arm extending between said lid actuator and said lid, said lid arm being positioned between said inner surface and said outer surface of said peripheral wall, said lid arm urging said lid into an open position when said pedal is urged into said opening position, said lid actuator biasing said lid into a closed position,
a plurality of clips, each of said clips comprising a first arm being coupled to a second arm, said second arm being oriented transversely with respect to said first arm such that each of said clips has a T-shape, said first arm having a distal end with respect to said second arm, said distal end being hingedly coupled to said outer surface of said peripheral wall, said clips being spaced apart from each other and distributed around said outer surface, each of said clips being aligned with an associated one of said slots, each of said clips being biased into an engaging position having said second arm of each of said clips being positioned in said associated slot, said bag being compressed between said second arm of each of said clips and said associated slot when said clips are biased into said engaging position, each of said clips being urgeable into a releasing position having said second arm of each of said clips being spaced from said associated slot such that said bag is removable from said trash can,
a clip actuator being positioned within said basal wall, said pedal being mechanically coupled to said clip actuator, and
a plurality of clip arms, each of said clip arms being coupled between said clip actuator and an associated one of said clips, each of said clip arms being positioned between said inner surface and said outer surface of said peripheral wall, each of said clip arms having a distal end with respect to said clip actuator, said distal end of each of said clip arms extending outwardly through said peripheral wall, said distal arm of each of said clip arms being coupled to said distal end of said associated clip, said clip actuator biasing each of said clips into said engaging position.
